(19) United States
(12) Patent Application Publication
(10) Pub. No.: US 2024/0152656 A1
(43) Pub. Date: May 9, 2024

(54) Systems and Methods for Non-Destructive Detection of Hardware Anomalies

(71) Applicant: Battelle Memorial Institute, Columbus, OH (US)

(72) Inventors: Giancarlo Canales Barreto, Dayton, OH (US); Nicholas L. Lamb, Upper Arlington, OH (US)

(21) Appl. No.: 18/549,371

(22) PCT Filed: Mar. 11, 2022
(86) PCT No.: PCT/US2022/019868

§ 371 Date: Sep. 7, 2023

(51) Int. Cl. G06F 21/71; G06F 21/55

(52) U.S. Cl. CPC G06F 21/71; G06F 21/554; G06F 2221/034

(57) ABSTRACT

In an approach to detecting hardware anomalies, a Radio Frequency (RF) signal emitted by a target device is received. The received signal from the target device is decomposed into a plurality of windows, where each window is a time slice. At least one hardware anomaly condition is determined for the target device based on a first hardware anomaly model and the plurality of windows. At least one predetermined action is determined based on the at least one hardware anomaly condition.

### CROSS-REFERENCE TO RELATED APPLICATIONS

The present application claims the benefit of the filing date of U.S. Provisional Application Ser. No. 63/160,601, filed Mar. 12, 2021, the entire teachings of which application is hereby incorporated herein by reference.

### TECHNICAL FIELD

The following disclosure relates generally to computer security, and more specifically to detecting hardware anomalies using Artificial Intelligence (AI).

### BACKGROUND

Numerous attack vectors exist that take advantage of analysis conducted against data emanations collected from a target device. These attacks are often called side-channel attacks because they operate in a passive manner and do not operate by sending signals into the device to cause erroneous behavior. Other techniques that are more aggressive in nature include glitching and similar techniques, which work by sending signals (Radio Frequency (RF), Optical, Magnetic, etc.) into the device to change the order of operations or alter decision-making logic within a processor or controller.

Often, cryptographic operations performed in hardware are targeted because success allows recovery of a private key or symmetric key. Other attacks include theft of intellectual property through the disabling of hardware security features. The theft can be the firmware or similar microprocessor configuration state that would allow others to reproduce the logic of the device under attack. Also, main processors and other associated hardware resources have physical performance limitations in the context of virtualization since they are tuned for general purpose computing. Some main processors include extensions to increase virtualization performance, but such extensions tend to be limited in functionality. Some host computers implement virtualization technologies (including spoofed ‘hardware’ presented to their guests) entirely in software (e.g., without the use of processor extensions) which is significantly slower than hardware and can also be more susceptible to attacks through flaws in either hardware or software. As such, there exists a need for a generalized approach to detecting hardware anomalies (including exploits/attacks) that avoids the computational costs and physical access requirements of existing approaches.

Artificial intelligence (AI) can be defined as the theory and development of computer systems able to perform tasks that normally require human intelligence, such as speech recognition, visual perception, decision-making, and translation between languages. The term AI is often used to describe systems that mimic cognitive functions of the human mind, such as learning and problem solving.

### SUMMARY

In one illustrative embodiment, a Radio Frequency (RF) signal emitted by a target device is received. The received signal from the target device is decomposed into a plurality of windows, where each window is a time slice. At least one hardware anomaly condition is determined for the target device based on a first hardware anomaly model and the plurality of windows. At least one predetermined action is determined based on the at least one hardware anomaly condition.

In another illustrative embodiment, a system for detecting hardware anomalies includes a Radio Frequency (RF) front-end; one or more computer processors; one or more computer readable storage media; and program instructions stored on the one or more computer readable storage media for execution by at least one of the one or more computer processors. The stored program instructions including instructions to: receive an RF signal emitted by a target device; decompose a received signal from the target device into a plurality of windows, wherein each window is a time slice; determine at least one hardware anomaly condition for the target device based on a first hardware anomaly model and the plurality of windows; and execute at least one predetermined action based on the at least one hardware anomaly condition.

In yet another illustrative embodiment, an apparatus for detecting hardware anomalies includes one or more computer processors; and a hardware anomaly detector. The hardware anomaly detector is configured to: receive an RF signal emitted by a target device; decompose a received signal from the target device into a plurality of windows, wherein each window is a time slice; determine at least one hardware anomaly condition for the target device based on a first hardware anomaly model and the plurality of windows; and execute at least one predetermined action based on the at least one hardware anomaly condition.

### BRIEF DESCRIPTION OF THE DRAWINGS

Reference should be made to the following detailed description which should be read in conjunction with the following figures, wherein like numerals represent like parts.

FIG. 1 shows an example system for detection of hardware anomalies consistent with the present disclosure.

FIG. 2 shows source code for causing/inducing a Flush primitive in an (ARM Cortex-A72) AArch64-based microprocessor implemented using C and inline assembly, in accordance with aspects of the present disclosure.

FIG. 3 shows additional source code for causing a Flush primitive in an Aarch64-based microprocessor consistent with aspects of the present disclosure.

FIG. 4 is a graph showing one example Operation Frequency Response (OFR) output by a hardware anomaly detector consistent with the present disclosure after a target device implemented as an AArch64 system executes instructions used to implement a Flush primitive.

FIG. 5 shows an example graph of an RF signal in the frequency domain during execution of a Flush primitive by a target device implemented as an AArch64 system.

FIG. 6 is a graph that shows a receiver operating characteristics (ROC) curve for detection of Spectre attack/exploit occurring on a target device implemented as an AArch64 system.

FIG. 7 is a graph that shows a time-lapse view of a Spectre attack/exploit occurring on a target device implemented as an AArch64 system.

### DETAILED DESCRIPTION

Modern microprocessors employ various optimization techniques such as caching and pipelining. These methods boost performance, but unfortunately, they also increase the microprocessor's complexity and open the door to unintended operations and exploits that can break hardware security policies. Well known examples of attacks that leverage these problems include Spectre and Meltdown attacks, which can be used to access otherwise-unavailable memory and information by exploiting cache timing side-channel leakages.

Timing side-channel attacks can be realized using cache attack primitives such as Evict+Time, Prime+Probe, Flush+Reload, Flush+Flush, and Prime+Abort. In turn, these primitives can be further broken down to: Evict, where cache data is replaced with new data; Time, where the amount of time it takes an operation to complete is measured, Prime; where a special condition within the system is triggered; Probe, where cache lines that were used are identified; Flush, where the cache is cleared; Reload, where the cache data is reloaded; and Abort, where a dummy transaction is initiated and eventually canceled.

These primitives can also be used to implement memory corruption attacks and can be considered a type of cache-like attack. One notable example is the Rowhammer attack which uses the Flush+Reload primitives to attack Dynamic Random-Access Memory (DRAM) implementations such as Double Data Rate 3 (DDR3) DRAM. Additionally, covert communication channels that use any of these primitives can also be included in this category.

Cache attacks can be detected by using software that runs locally on a target and analyzes performance counters in the microprocessor. This approach is possible because these attacks are repetitive, and in some cases can take days to successfully execute, as is the case with the ECCPloit attack. An alternative approach is to employ software mitigations which result in performance degradation.

In view of the foregoing, this disclosure recognizes that existing techniques for detection of exploits/attacks and other hardware anomalies are often special-purpose and tailored for explicit results against specific target platforms. Often these techniques require a long period of time to operate (e.g., up to days/weeks) and generally require physical access to a target device (or execution access on the physical device).

As such, there exists a need for a generalized approach to detecting hardware anomalies (including exploits/attacks) that avoids the computational costs and physical access requirements of existing approaches. Further, there exists a need for a generalized approach to detecting hardware anomalies using predetermined primitives that allow a computer-implemented process to detect the “signature” of such hardware anomalies using machine learning, artificial intelligence, and/or other suitable computer-implemented logic processing approaches. Moreover, it is desirable that such detection of hardware anomalies is highly accurate such that false positives are minimized or otherwise reduced, and that accuracy can be improved over time through training and validation.

Thus, systems and methods of detecting general hardware anomalies using a model-based approach are provided herein. The systems and methods for detection of such hardware anomalies operate external from a target device being monitored, and thus by extension, do not require code execution within the target device being monitored.

Systems and methods consistent with the present disclosure utilize hardware anomaly models, which are configured/trained to detect one or more hardware anomaly conditions. Systems and methods consistent with the present disclosure utilize the hardware anomaly models within one or more implemented artificial intelligence (AI) technologies, which may include, but are not limited to, machine learning (ML), deep learning, e.g., neural networks (NN), etc., which enable the non-destructive detection of hardware anomalies.

As generally referred to herein, non-destructive detection refers to a detection scheme that does not require introduction of signal(s) or disruption of a target device to detect hardware anomalies. Such non-destructive detection also refers to detection of hardware anomalies that does not require execution of code on a target device or otherwise introduce latency/performance degradation on the same. Moreover, the non-destructive detection of anomalies can monitor for powered-on (e.g., live, runtime) and powered-off (e.g., injected electromagnetic (EM) signals that may toggle hardware state at the transistor level while the device is inactive).

Models consistent with the present disclosure are trained on innocuous/non-malicious input data but can detect deviations from normal functionality that can be caused by hardware faults including, but not limited to, components beginning to wear out and fail, and/or via malicious activity (e.g., a cyberattack). This is in contrast to existing methods that are either destructive in nature (e.g., random sampling to detect deviations) or solutions that operate by analyzing alternate characteristics (e.g., power utilization).

Thus, aspects and features of the present disclosure enable an out-of-band cache attack monitoring system that leverages statistical machine learning models to detect n-day and zero-day hardware attacks. The present disclosure has identified that certain instructions executed by a microprocessor, such as those associated with the Flush primitive, can be identified by capturing associated electromagnetic waves, such as RF emanations from the processor. In the context of attacks based on the Flush primitive, for example, this enables for the signature recognition of attack variants such as the Spectre attack. Experimental results based on a target device implemented with an ARM Cortex-A72 (AArch64) microprocessor, such as is found in the Raspberry Pi 4 Model B, are provided below.

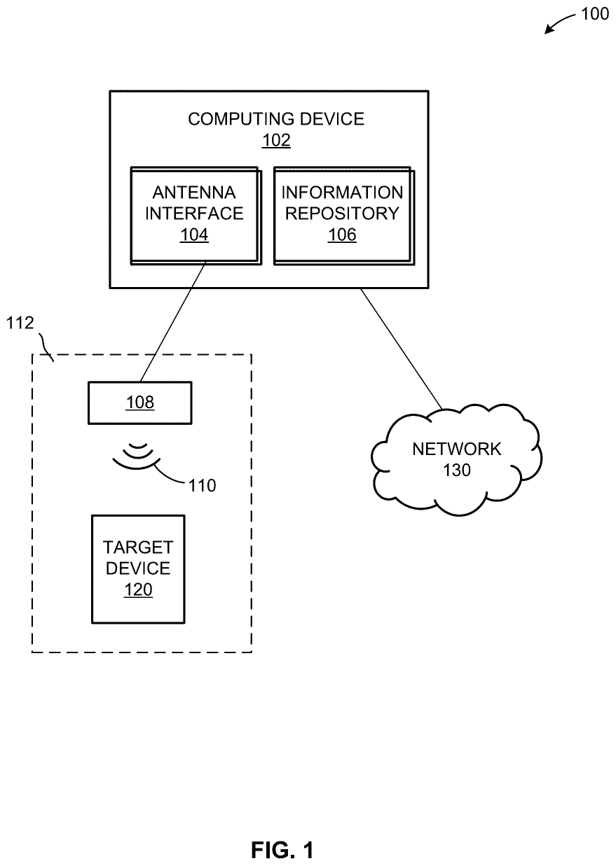

FIG. 1 is a functional block diagram illustrating one example configuration of a system 100 for providing hardware anomaly detection. FIG. 1 provides only an illustration of one implementation and does not imply any limitations with regard to the environments in which different embodiments may be implemented. Many modifications to the depicted environment may be made by those skilled in the art without departing from the scope of the disclosure as recited by the claims.

The particular example and scenarios discussed below are particularly well suited for the generation, training and/or validation of hardware anomaly models consistent with the present disclosure. However, this disclosure is not necessarily limited in this regard. For example, generated hardware anomaly models consistent with the present disclosure may then be utilized by the system 100 for detection purposes, or by other computer systems configured with processes consistent with the present disclosure. The system 100 comprises a target device 120 and a computing device 102.

System 100 includes computing device 102 optionally connected to network 130. Network 130 can be, for example, a telecommunications network, a local area network (LAN), a wide area network (WAN), such as the Internet, or a combination of the three, and can include wired, wireless, or fiber optic connections. Network 130 can include one or more wired and/or wireless networks that are capable of receiving and transmitting data, voice, and/or video signals, including multimedia signals that include voice, data, and video information. In general, network 130 can be any combination of connections and protocols that will support communications between computing device 102 and other computing devices (not shown) within system 100.

Computing device 102 can be a standalone computing device, a mobile computing device, or any other electronic device or computing system capable of receiving, sending, and processing data. In another embodiment, computing device 102 can represent a server computing system utilizing multiple computers as a server system, such as in a cloud computing environment. In yet other embodiments, computing device 102 may be a plurality of separate computing devices that are communicatively coupled, e.g., through network 130. Computing device 102 may include one or more computer processors.

In an embodiment, computing device 102 includes information repository 106. In an embodiment, information repository 106 may be managed by the computing device 102. In an alternate embodiment, information repository 106 may be managed by the operating system of the computing device 102, alone, or together with, the computing device 102. Information repository 106 is a data repository that can store, gather, compare, and/or combine information. In some embodiments, information repository 106 is located externally to computing device 102 and accessed through a communication network, such as network 130. In some embodiments, information repository 106 is stored on computing device 102. In some embodiments, information repository 106 may reside on another computing device (not shown), provided that information repository 106 is accessible by computing device 102. Information repository 106 includes, but is not limited to, one or more hardware anomaly models. Each hardware anomaly model can be configured to detect one or more hardware anomaly conditions for a target device. Some such example hardware anomaly conditions can include a hardware failure such as a mechanical failure (e.g., a physical component stuck/jammed in a particular state), a hardware failure caused by overheating or heating/cooling/heating cycles, or an exploit attack occurring on the target device 120 such as a cache attack or memory attack, or through covert communication. A hardware anomaly model consistent with the present disclosure may be implemented to comport with a target computer-based logic processing approach such as those utilized in AI, including ML and NN.

Information repository 106 may be implemented using any non-transitory volatile or non-volatile storage media for storing information, as known in the art. For example, information repository 106 may be implemented with random-access memory (RAM), semiconductor memory, solid-state drives (SSD), one or more independent hard disk drives, multiple hard disk drives in a redundant array of independent disks (RAID), or an optical disc. Similarly, information repository 106 may be implemented with any suitable storage architecture known in the art, such as a relational database, an object-oriented database, or one or more tables.

The computing device 102 includes an RF front-end, which further includes an antenna arrangement including an antenna interface 104 (or antenna interface circuit) electrically coupled to an antenna 108. In the example of FIG. 1, the antenna 108 is implemented as an Aariona MDF 9400 antenna with a frequency range of 9 kHz to 400 MHz, although many other antenna configurations and frequency ranges are contemplated and are within the scope of this disclosure.

In some embodiments, the target device 120 comprises a computer device having a microprocessor. One example of the target device 120 may be a Raspberry Pi 4 (RPi4) having a microprocessor that comports with the AArch64 architecture. However, the target device 120 is not limited in this regard and various aspects and features of the present disclosure are equally applicable to other device types/processor architectures with minor modification.

As further shown, the antenna 108 is disposed adjacent the target device 120 to receive RF signal 110 therefrom. In this example, the target device 120 and antenna 108 are disposed within an RF-shielded enclosure 112. The RF signal 110 emitted by the target device 120 can be based on RF emissions of a processor of the target device 120 executing instructions. Thus, the RF signal 110 can include representations of the instructions executed on the processor of the target device 120. Such representations of instructions within the RF signal 110 may thus collectively provide a signature by which hardware anomaly models consistent with the present disclosure can detect hardware anomalies. Note, this disclosure is not necessarily limited to processing of RF signals. Features and aspects of the present disclosure are equally applicable to other measurable energies such as those available across the electromagnetic spectrum including power consumption, EM radiation, ground electric potential, etc.

In FIG. 1, the computing device 102 is configured to receive the RF signal 110 via the antenna 108 and the antenna interface 104. However, it should be noted that the computing device 102 may not necessarily receive the RF signal via the antenna 108, and instead, the RF signal 110 may be captured at a previous time and received by the hardware anomaly detector via a file transfer from a remote location, e.g., from a cloud-storage location, from a USB stick, and so on. Thus, hardware anomaly condition detection routines/processes consistent with the present disclosure may be executed by the computing device 102 in a real-time or “offline” manner, depending on a desired configuration.

The computing device 102 is configured to detect at least one hardware anomaly condition for the target device 120 based on applying a hardware anomaly model consistent with the present disclosure to the RF signal 110 received by the computing device 102. In one example, the computing device 102 uses one or more of such hardware anomaly models to detect one or more target processor instructions represented within the RF signal 110, and more importantly, the presence of a predetermined exploit occurring on the target device 120 based on the detected one or more target processor instructions. Note, the hardware anomaly models may also be configured to detect unknown exploits based on, for example, patterns of primitive behaviors. For example, if a high number of the cache primitives (Flush, Time, Probe, and so on) are executed, a hardware anomaly model can detect such activity and cause execution of one or more predetermined actions, examples of which are discussed further below.

The computing device 102 may then detect a hardware anomaly condition based on the output of one or more of the hardware anomaly models. A hardware anomaly model consistent with the present disclosure may include utilizing a multi-variate Gaussian Probability Density Function (PDF), the output of which may then be utilized by the computing device 102 to detect a particular hardware anomaly condition. The output may also provide a confidence value that indicates, e.g., via a percent value, the relative probability that a detected hardware condition is occurring.

In some embodiments, the computing device 102 is configured to execute one or more predetermined actions based on detecting a hardware anomaly, or the lack thereof, as the case may be. Some example predetermined actions may include the computing device 102 causing an alert to be presented to a user, e.g., via a SMS message or via a display associated with the computing device 102. The alert can include an indication of the detected hardware condition. For instance, the alert can include an indicator (e.g., a string such as “CPU hardware anomaly detected in sensor array virtual machine guest” or “Spurious cache flushes detected in CPU”) of which hardware component is failing and the type of failure which is occurring. For exploit detection, this can include an indicator of a detected type of the exploit, and optionally, the confidence value for the detected exploit. Other type of indicators can include audible indicators such as a pre-recorded sound or tone.

Alternatively, or in addition to a user alert, the at least one predetermined action can include the computing device 102 executing a corrective action. This execution of a corrective action can occur automatically, e.g., without user intervention, or require user intervention depending on a desired configuration. Some such example corrective actions include causing a guest virtual machine to reboot or toggling an input line to a backup sensor to occur on target device 120.

In some cases, a detected condition can include so-called ‘healthy’ conditions, e.g., a condition in which no hardware failures and/or exploits are detected on the target device 120. In this scenario, the computing device 102 may therefore be configured to execute a predetermined action as described above at a predetermined interval, and/or upon user request.

For purposes of training and/or verification of a hardware anomaly model consistent with the present disclosure, a target exploit type may be simulated on the target device 120 and used to generate the RF signal 110 with representations of instructions that indicate that particular target exploit.

One such example exploit capable of being executed on the target device 120 includes a cache attack in the form of a Flush-type attack. This disclosure has identified that such an attack may then be simulated via code and used to generate the RF signal 110 with the features/indicators of that attack.

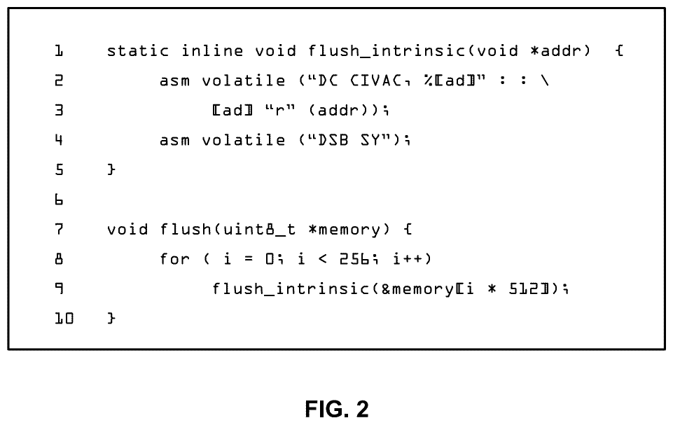

For example, Flush cache-attack primitive can be implemented in x86_64 processors using the CFLUSH instruction. In AArch64 processors, the primitive can be implemented using the DC CIVAC (Data Cache maintenance, Clean Invalidate by Virtual Address to the point of Coherency) and DSB SY (Data Synchronization Barrier, full SYstem) instructions. An example implementation of the Flush primitive for AArch64 is shown in FIG. 2.

The DC CIVAC instruction flushes a cache line asynchronously, and in order to ensure completion of this routine, the DSB SY instruction is needed, which blocks execution until the maintenance routine finishes.

Accordingly, the Flush primitive for AArch64 can be implemented using DC CIVAC and DSB SY and can be used to create training programs for use by hardware anomaly models consistent with the present disclosure. In one example, two such programs are created and executed serially, and the corresponding RF signal/emanations, e.g., RF signal 110, are repeatedly captured and stored as training data within the information repository 106 to enable creation of a statistical machine learning model as discussed below.

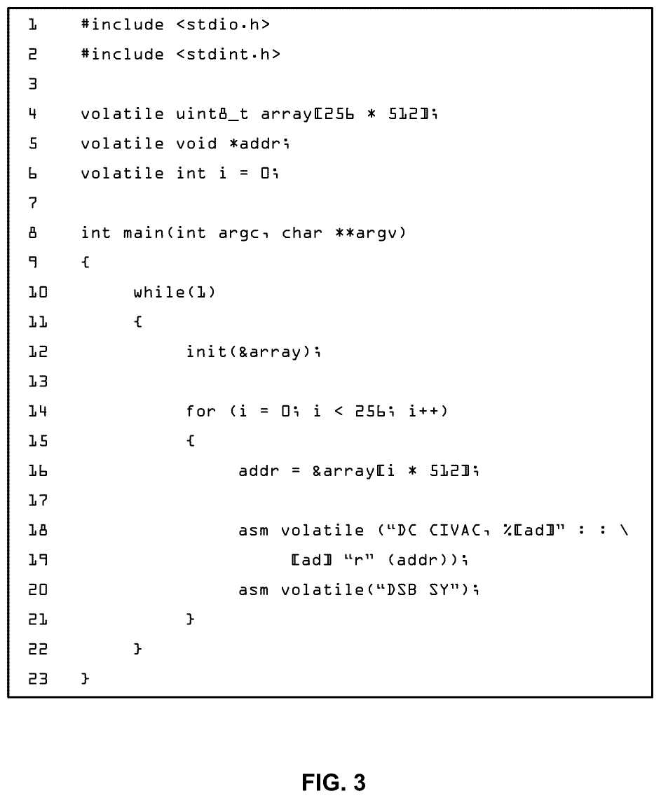

A simplified version of the training program of FIG. 2 is shown in FIG. 3. The source code in FIG. 3 includes the DC CIVAC and DSB SY instructions. In operation, this program infinitely initializes the array and flushes the cache. In order to prevent compiler optimizations that would yield unwanted differences in the program, the code shown in FIG. 3 can be compiled into intermediate assembly and split into two programs that each include only one of the DC and DSB cache instructions.

The following discussion includes one example approach for processing of an RF signal output from a microprocessor executing the source code of FIG. 3, and detection of a hardware anomaly therefrom in accordance with aspects of the present disclosure.

In operation, an RF signal such as the RF signal 110 is obtained by the computing device 102 by way of the antenna interface 104 and antenna 108. In one experimental configuration, such signals were obtained by implementing the antenna interface 104 as a HackRF One Software Defined Radio (SDR) with a center frequency of fc=10 MHz and a sampling rate of fs=20 MS/s.

The received RF signal may than be decomposed into a plurality of time slices called windows. The decomposed RF signal may then be decomposed, digitized, and stored as In-Phase/Quadrature (I/Q) data, or signal components, which are a type of analytic signal that is represented using complex numbers. In one example, approximately five (5) seconds of RF signal is acquired for each executed training program. The RF signal may then be digitized and sliced into, for example, 1 millisecond (ms) windows, and normalized so that the mean (μ)=0 and the standard deviation (σ)=1.

After the received RF signal is sliced and normalized, the Power Spectral Density (PSD) of each trace x[n] can be estimated using a discrete Fourier Transform (DFT), as shown in Equation (1):

$$10 \cdot {log}_{10} {\vert {\sum }_{n = 0}^{N - 1} x [ n ] \cdot {e}^{- \frac{j 2 π}{N} kn} \vert}^{2} \qquad Equation ( 1 )$$

After the signals are sliced and normalized, the Power Spectral Density (PSD) of each trace x[n] is estimated using the DFT, as shown in Equation (1). The absolute value of a complex number is defined as |a+bi|=\sqrt{a²+b²}. Additionally, the average power spectral density of the windows can be computed. The resulting PSD is referred to herein as the Operation Frequency Response (OFR) and can be used to sense the execution of DC CIVAC and DSB SY instructions. The combination of these two OFRs is also known as the Flush OFR herein.

In order to determine whether an instruction is being executed, a statistical machine learning technique called model/template analysis may be utilized. This approach utilizes a multi-variate Gaussian PDF. An example 3-variable Gaussian PDF is shown in Equation (2), and the corresponding covariance matrix Σ and mean vector μ are shown in Equations (3, 4), where the variables fₓ, f_{y} and f_{z} are random variables.

$$f ( x ) = \frac{1}{\sqrt{{( 2 π )}^{k} det Σ}} exp ( - \frac{1}{2} {( x - μ )}^{T} {Σ}^{- 1} ( x - μ ) ) \qquad Equation ( 2 )$$

The random variables fₓ, fy and f_{z} correspond to three distinct points of interest within the OFR, i.e., three different frequency offsets that encode information unique to the target instruction that a hardware anomaly detector consistent with the present disclosure is attempting to detect. These points can be selected by measuring the absolute sum of differences between the OFR of DC CIVAC and DSB SY. Frequencies with the highest power difference are selected as the points of interest.

$$\begin{matrix}Σ = [ \begin{matrix}Var ( {f}_{x} ) & Cov ( {f}_{x} , {f}_{y} ) & Cov ( {f}_{x} , {f}_{z} ) \\ Cov ( {f}_{y} , {f}_{x} ) & Var ( {f}_{y} ) & Cov ( {f}_{y} , {f}_{z} ) \\ Cov ( {f}_{z} , {f}_{x} ) & Cov ( {f}_{z} , {f}_{y} ) & Var ( {f}_{z} )\end{matrix} ] & Equation ( 3 ) \\ μ = [ \begin{matrix}{μ}_{fx} \\ {μ}_{fy} \\ {μ}_{fz}\end{matrix} ] & Equation ( 4 )\end{matrix}$$

Thus, a hardware anomaly model consistent with the present disclosure can be provided by a PDF and OFR as determined above via Equations (1) and (2). A hardware anomaly model consistent with the present disclosure can be used to determine the probability that a particular instruction is executing by feeding it an OFR's points of interests.

Experimental Results: in one experiment, hardware anomaly models were generated for detection of DC CIVAC and DSB SY instructions, which then can be used to determine if a Spectre attack is being conducted on a target device. The configuration of the experiment included a system consistent with the system 100 of FIG. 1 and utilized two Spectre programs to conduct this form of attack and to generate the resulting RF signal. The first program lacked cache flush operations, and as such fails to successfully attack the system, whereas the second Spectre program does include cache instructions and successfully attacks the system. Finally, the experiment included determining the OFR for each program and inputting the OFRs into a corresponding hardware anomaly model configured to detect Spectre attacks. Note, this hardware anomaly model used to detect Spectre was trained using the Flush OFR instead of the Spectre OFR.

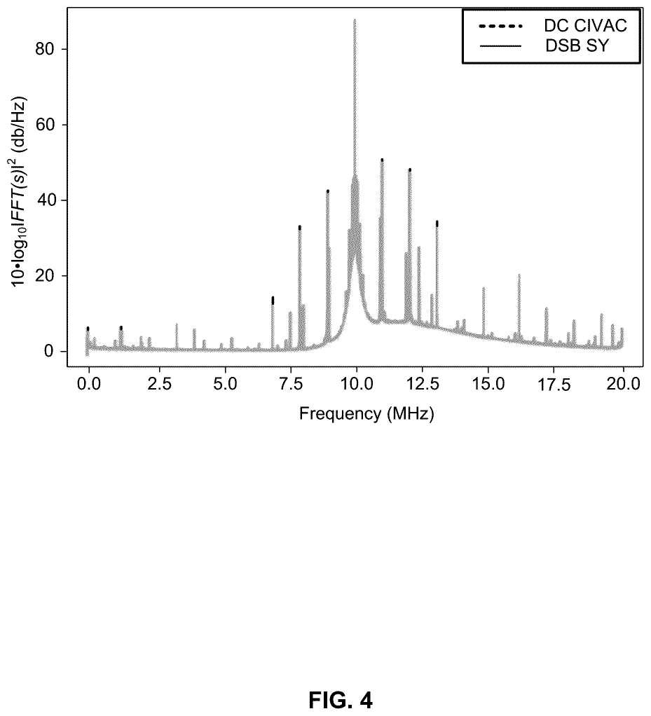

The experimental results suggest that the Flush OFR model classification method generalizes well and can be used to accurately detect a Spectre attack on an AArch64 microprocessor that is running at 1.5 GHz. The average Flush OFR for this device type is shown in FIG. 4. Notably, it was observed that there appears to be evenly spaced harmonics associated with the operations shown in FIG. 4. It should be noted, however, that the present disclosure is not necessarily limited to a microprocessor running at 1.5 GHz, and other processor configurations and clock speeds are within the scope of this disclosure.

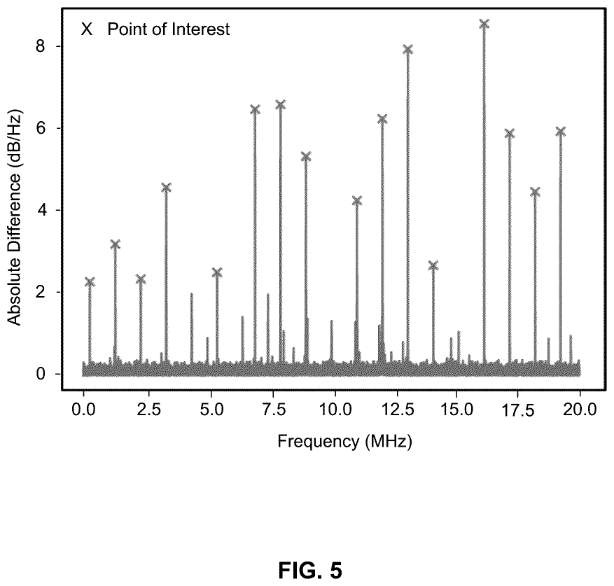

Differences across the frequencies between OFRs are shown in FIG. 5. As shown, the top sixteen frequency offsets with the highest power difference are indicated at their peak with an ‘x’ character. FIG. 5 appears to demonstrate that spurs of energy at multiples of 1 MHz occur, and this disclosure theorizes that each one of these spikes generated by interactions between the loops used to implement the flush operation and the scheduling algorithm employed by the Linux operating system of the target device. Both of these mechanisms can be seen as oscillators that run at a frequency that is much lower than the processor's clock.

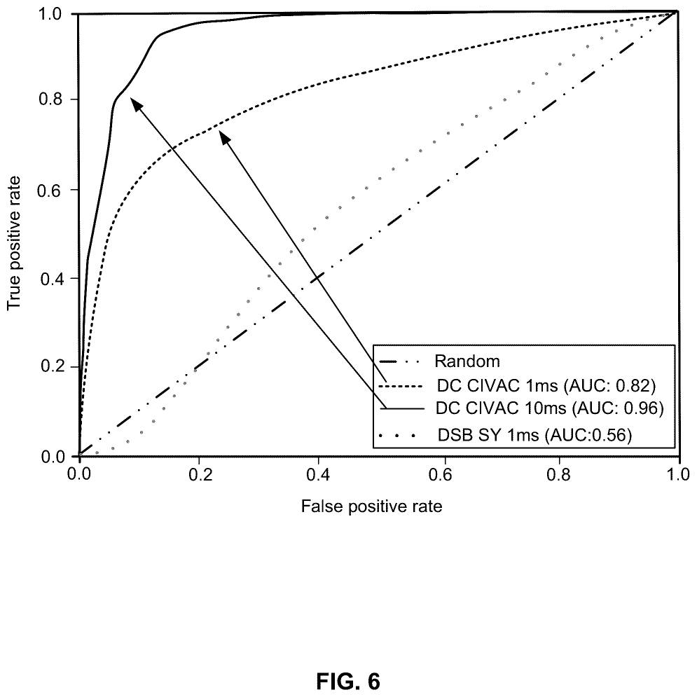

In order to characterize the specificity and sensitivity of the generated hardware anomaly model used to detect Spectre, a Receiver Operating Characteristic (ROC) curve was generated and is shown in FIG. 6. The Area Under the Curve (AUC) for each model is also shown in FIG. 6.

The ROC curve suggests that Spectre can be detected with a concordance statistic of 96% when evaluating a 10 ms window using the DC CIVAC model. The DSB SY model has a concordance statistic of 56%, which is high enough to be statistically significant for some detection purposes.

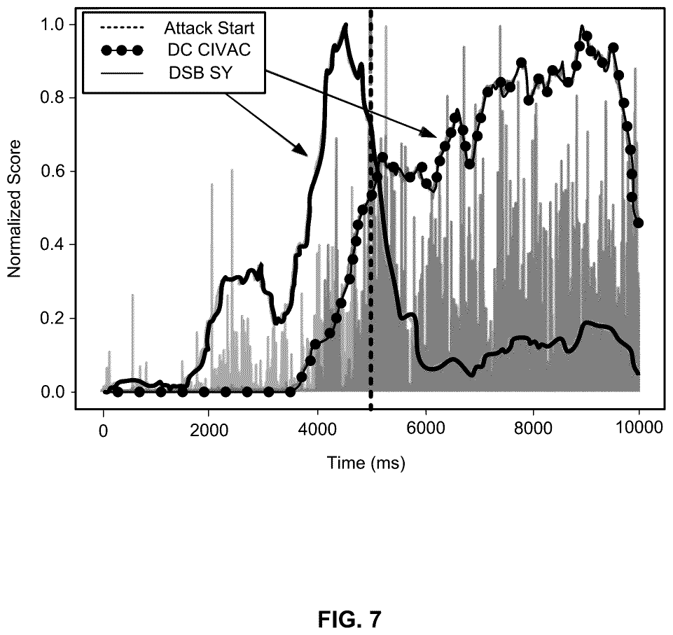

An alternative view based on the data used to generate the ROC is presented in FIG. 7 for purposes of additional clarity. FIG. 7 shows a time-lapse view of the detection of Spectre occurring on a target device implementing an AArch64 system. The background portions of the graph represent the output value of the DC CIVAC and DSB SY models respectively, and the overlaid lines show the 1s moving average of each hardware anomaly model's output. The plot of FIG. 7 shows how the noise distribution and mean of the probability density function's output varies over time when the Spectre attack is running and when the Spectre attack is not running.

The experimental results confirmed the hardware anomaly detection approach disclosed herein provides an accurate approach for detecting other Flush-based attacks like Meltdown and Rowhammer. Furthermore, aspects and features of the present disclosure can be extended to support other processor attacks, architectures, instructions, and primitives.

Other applications of the OFR model concept disclosed herein include an instruction decompiler that may determine which instructions are being executed within a black box system that has a known microprocessor. Finally, the classification algorithms can be further refined to improve performance. Such performance increases can be achieved by utilizing a more sensitive SDR, phase locking the SDR with the target device, utilizing Low Noise Amplifiers (LNA), and/or further filtering out of unwanted frequencies. Specifically, a SDR with higher quality sampling but at a narrower bandwidth covering collection at specific emanation frequencies reduces the cost of the acquisition system, reduces superfluous signal collection (and associated data), and improves the specificity of the signals collected. Similarly, LNAs are beneficial enhancements since side channel emanations are by definition unintended signals and are often considered noise that exists in a chaotic environment that can cause collection and processing issues. These LNAs boost the relative signal strength of the noise frequencies with minimal impact on the quality of the associated signals. This allows these frequencies to become more apparent and allows AI/ML platforms to derive more accurate models.

In one example, aspects of the present disclosure can be implemented within one or more virtual System-On-Chip (vSoC) instances, which are systems and methods generally directed to implementing one or more SoC instances within reconfigurable hardware to accelerate virtualized system components and securely isolate virtualized system components. An orchestrator is a component of a vSoC that controls the provisioning, de-provisioning, management, and supervision of the vSoC instances. An orchestrator of a vSoC instance can be configured to receive a signal from an intrusion detection module configured consistent with the present disclosure. In this example, the orchestrator may then perform introspection on the guest to narrow down and potentially quarantine or fix the detected issue based on the output of the intrusion detection module Note, aspects and features of the present disclosure may also be integrated into virtually any existing hypervisor or operating system as an attack alarm and/or hardware failure detector.

Aspects and features of the present disclosure are applicable in a wide range of applications including medical, finance, data center, automotive, industrial automation, defense, aerospace and virtually any application in which detection of hardware failures and/or exploitation attacks is desirable.

According to one aspect of the present disclosure, there is thus provided a computer-implemented method for providing hardware anomaly detection. The computer-implemented method includes: receiving, by one or more computer processors, a Radio Frequency (RF) signal emitted by a target device; decomposing, by the one or more computer processors, a received signal from the target device into a plurality of windows, wherein each window is a time slice; determining, by the one or more computer processors, at least one hardware anomaly condition for the target device based on a first hardware anomaly model and the plurality of windows; and executing, by the one or more computer processors, at least one predetermined action based on the at least one hardware anomaly condition.

In this computer-implemented method, the first hardware anomaly model uses artificial intelligence.

In this computer-implemented method, the artificial intelligence is selected from the group consisting of machine learning, neural networks, and combinations thereof.

In this computer-implemented method, the first hardware anomaly model is trained to detect at least one of a hardware failure caused by a mechanical failure, the hardware failure caused by overheating, the hardware failure caused by heating/cooling/heating cycles, a cache attack, a memory attack, other exploit attack, covert communication, and combinations thereof.

In this computer-implemented method, the at least one hardware anomaly condition for the target device comprises an unknown exploit occurring on the target device.

In this computer-implemented method, the at least one predetermined action includes causing an alert to be displayed to a user.

In this computer-implemented method, the at least one hardware anomaly condition comprises a first detected hardware anomaly condition and a second detected hardware anomaly condition, and wherein the first detected hardware anomaly condition comprises a hardware failure condition and the second detected hardware anomaly condition comprises a predetermined exploit occurring on the target device.

In this computer-implemented method, the received signal is decomposed from the target device into the plurality of windows, wherein each window is the time slice further comprises: decomposing, by the one or more computer processors, the received signal into In-Phase/Quadrature (I/Q) data.

In this computer-implemented method, determining the at least one hardware anomaly condition for the target device based on the first hardware anomaly model and the plurality of windows further comprises: determining, by the one or more computer processors, a power spectral density of each window of the plurality of windows, wherein the power spectral density is determined using a discrete Fourier Transform; and determining, by the one or more computer processors, whether an instruction is being executed on the target device using a multi variate Gaussian probability density function, wherein the multi variate Gaussian probability density function is a statistical machine learning technique.

According to another aspect of the present disclosure, there is thus provided a system for providing hardware anomaly detection. The system includes: a Radio Frequency (RF) front-end; one or more computer processors; one or more computer readable storage media; and program instructions stored on the one or more computer readable storage media for execution by at least one of the one or more computer processors, the stored program instructions including instructions to: receive an RF signal emitted by a target device; decompose a received signal from the target device into a plurality of windows, wherein each window is a time slice; determine at least one hardware anomaly condition for the target device based on a first hardware anomaly model and the plurality of windows; and execute at least one predetermined action based on the at least one hardware anomaly condition.

In this system, the RF front-end further comprises: an antenna interface; and an antenna, wherein the antenna is electrically coupled to the antenna interface.

In this system, the first hardware anomaly model uses artificial intelligence.

In this system, the artificial intelligence is selected from the group consisting of machine learning, neural networks, and combinations thereof.

In this system, the first hardware anomaly model is trained to detect at least one of a hardware failure caused by a mechanical failure, the hardware failure caused by overheating, the hardware failure caused by heating/cooling/heating cycles, a cache attack, a memory attack, other exploit attack, covert communication, and combinations thereof.

In this system, the at least one hardware anomaly condition for the target device comprises an unknown exploit occurring on the target device.

In this system, the at least one predetermined action includes causing an alert to be displayed to a user.

In this system, the at least one hardware anomaly condition comprises a first detected hardware anomaly condition and a second detected hardware anomaly condition, and wherein the first detected hardware anomaly condition comprises a hardware failure condition and the second detected hardware anomaly condition comprises a predetermined exploit occurring on the target device.

In this system, the received signal is decomposed from the target device into the plurality of windows, wherein each window is the time slice further comprises one or more of the following program instructions, stored on the one or more computer readable storage media, to: decompose the received signal into In-Phase/Quadrature (I/Q) data.

In this system, determine the at least one hardware anomaly condition for the target device based on the first hardware anomaly model and the plurality of windows further comprises one or more of the following program instructions, stored on the one or more computer readable storage media, to: determine a power spectral density of each window of the plurality of windows, wherein the power spectral density is determined using a discrete Fourier Transform; and determine whether an instruction is being executed on the target device using a multi variate Gaussian probability density function, wherein the multi variate Gaussian probability density function is a statistical machine learning technique.

According to yet another aspect of the present disclosure, there is thus provided an apparatus for providing hardware anomaly detection. The apparatus includes: one or more computer processors; and a hardware anomaly detector configured to: receive an RF signal emitted by a target device; decompose a received signal from the target device into a plurality of windows, wherein each window is a time slice; determine at least one hardware anomaly condition for the target device based on a first hardware anomaly model and the plurality of windows; and execute at least one predetermined action based on the at least one hardware anomaly condition.

In this apparatus, the hardware anomaly detector further comprises: an antenna interface; and an antenna, wherein the antenna is electrically coupled to the antenna interface.

In this apparatus, the one or more computer processors are further configured to use artificial intelligence, and further wherein the artificial intelligence is selected from the group consisting of machine learning, neural networks, and combinations thereof.

In this apparatus, the first hardware anomaly model is trained to detect at least one of a hardware failure caused by a mechanical failure, the hardware failure caused by overheating, the hardware failure caused by heating/cooling/heating cycles, a cache attack, a memory attack, other exploit attack, covert communication, and combinations thereof.

In this apparatus, the received signal is decomposed from the target device into the plurality of windows, wherein each window is the time slice further comprises one or more of the following program instructions, stored on the one or more computer readable storage media, to: decompose the received signal into In-Phase/Quadrature (I/Q) data.

In this apparatus, the hardware anomaly detector is further configured to: determine a power spectral density of each window of the plurality of windows, wherein the power spectral density is determined using a discrete Fourier Transform; and determine whether an instruction is being executed on the target device using a multi variate Gaussian probability density function, wherein the multi variate Gaussian probability density function is a statistical machine learning technique.

The present disclosure may be a system, a method, and/or an apparatus. The system may include a computer readable storage medium (or media) having computer readable program instructions thereon for causing a processor to carry out aspects of the present disclosure.

The computer readable storage medium can be any tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or other programmable logic devices (PLD) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, and apparatus (systems) according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

From the foregoing it will be appreciated that, although specific examples have been described herein for purposes of illustration, various modifications may be made without deviating from the spirit and scope of the disclosure described herein. Accordingly, the disclosure is not limited except as by corresponding claims and the elements recited by those claims. In addition, while certain aspects of the disclosure may be presented in certain claim forms at certain times, the inventors contemplate the various aspects of the disclosure in any available claim form. For example, while only some aspects of the disclosure may be recited as being embodied in a computer-readable medium at particular times, other aspects may likewise be so embodied.

What is claimed is:

1. A computer-implemented method for providing hardware anomaly detection, the computer-implemented method comprising:
receiving, by one or more computer processors, a Radio Frequency (RF) signal emitted by a target device;
decomposing, by the one or more computer processors, the received signal from the target device into a plurality of windows, wherein each window is a time slice;
determining, by the one or more computer processors, at least one hardware anomaly condition for the target device based on a first hardware anomaly model and the plurality of windows; and
executing, by the one or more computer processors, at least one predetermined action based on the at least one hardware anomaly condition.

2. The computer-implemented method of claim 1, wherein the first hardware anomaly model uses artificial intelligence.

3. The computer-implemented method of claim 2, wherein the artificial intelligence is selected from the group consisting of machine learning, neural networks, and combinations thereof.

4. The computer-implemented method of claim 2, wherein the first hardware anomaly model is trained to detect at least one of a hardware failure caused by a mechanical failure, the hardware failure caused by overheating, the hardware failure caused by heating/cooling/heating cycles, a cache attack, a memory attack, other exploit attack, covert communication, and combinations thereof.

5. The computer-implemented method of claim 1, wherein the at least one hardware anomaly condition for the target device comprises an unknown exploit occurring on the target device.

6. The computer-implemented method of claim 1, wherein the at least one predetermined action includes causing an alert to be displayed to a user.

7. The computer-implemented method of claim 1, wherein the at least one hardware anomaly condition comprises a first detected hardware anomaly condition and a second detected hardware anomaly condition, and wherein the first detected hardware anomaly condition comprises a hardware failure condition and the second detected hardware anomaly condition comprises a predetermined exploit occurring on the target device.

8. The computer-implemented method of claim 1, wherein decomposing the received signal from the target device into the plurality of windows, wherein each window is the time slice further comprises:
decomposing, by the one or more computer processors, the received signal into In-Phase/Quadrature (I/Q) data.

9. The computer-implemented method of claim 1, wherein determining the at least one hardware anomaly condition for the target device based on the first hardware anomaly model and the plurality of windows further comprises:
determining, by the one or more computer processors, a power spectral density of each window of the plurality of windows, wherein the power spectral density is determined using a discrete Fourier Transform; and
determining, by the one or more computer processors, whether an instruction is being executed on the target device using a multi-variate Gaussian probability density function, wherein the multi-variate Gaussian probability density function is a statistical machine learning technique.

10. A system for providing hardware anomaly detection, the system comprising:
a Radio Frequency (RF) front-end;
one or more computer processors;
one or more computer readable storage media; and
program instructions stored on the one or more computer readable storage media for execution by at least one of the one or more computer processors, the stored program instructions including instructions to:
receive an RF signal emitted by a target device;
decompose the received signal from the target device into a plurality of windows, wherein each window is a time slice;
determine at least one hardware anomaly condition for the target device based on a first hardware anomaly model and the plurality of windows; and
execute at least one predetermined action based on the at least one hardware anomaly condition.

11. The system of claim 10, wherein the RF front-end further comprises:
an antenna interface; and
an antenna, wherein the antenna is electrically coupled to the antenna interface.

12. The system of claim 10, wherein the first hardware anomaly model uses artificial intelligence.

13. The system of claim 12, wherein the artificial intelligence is selected from the group consisting of machine learning, neural networks, and combinations thereof.

14. The system of claim 12, wherein the first hardware anomaly model is trained to detect at least one of a hardware failure caused by a mechanical failure, the hardware failure caused by overheating, the hardware failure caused by heating/cooling/heating cycles, a cache attack, a memory attack, other exploit attack, covert communication, and combinations thereof.

15. The system of claim 10, wherein the at least one hardware anomaly condition for the target device comprises an unknown exploit occurring on the target device.

16. The system of claim 10, wherein the at least one predetermined action includes causing an alert to be displayed to a user.

17. The system of claim 10, wherein the at least one hardware anomaly condition comprises a first detected hardware anomaly condition and a second detected hardware anomaly condition, and wherein the first detected hardware anomaly condition comprises a hardware failure condition and the second detected hardware anomaly condition comprises a predetermined exploit occurring on the target device.

18. The system of claim 10, wherein decompose the received signal from the target device into the plurality of windows, wherein each window is the time slice further comprises one or more of the following program instructions, stored on the one or more computer readable storage media, to:
decompose the received signal into In-Phase/Quadrature (I/Q) data.

19. The system of claim 10, wherein determine the at least one hardware anomaly condition for the target device based on the first hardware anomaly model and the plurality of windows further comprises one or more of the following program instructions, stored on the one or more computer readable storage media, to:
determine a power spectral density of each window of the plurality of windows, wherein the power spectral density is determined using a discrete Fourier Transform; and
determine whether an instruction is being executed on the target device using a multi variate Gaussian probability density function, wherein the multi variate Gaussian probability density function is a statistical machine learning technique.

20. An apparatus for providing hardware anomaly detection comprising:
one or more computer processors; and
a hardware anomaly detector configured to:
receive an RF signal emitted by a target device;
decompose the received signal from the target device into a plurality of windows, wherein each window is a time slice;
determine at least one hardware anomaly condition for the target device based on a first hardware anomaly model and the plurality of windows; and
execute at least one predetermined action based on the at least one hardware anomaly condition.

21. The apparatus of claim 20, wherein the hardware anomaly detector further comprises:
an antenna interface; and
an antenna, wherein the antenna is electrically coupled to the antenna interface.

22. The apparatus of claim 20, wherein the one or more computer processors are further configured to use artificial intelligence, and further wherein the artificial intelligence is selected from the group consisting of machine learning, neural networks, and combinations thereof.

23. The apparatus of claim 20, wherein the first hardware anomaly model is trained to detect at least one of a hardware failure caused by a mechanical failure, the hardware failure caused by overheating, the hardware failure caused by heating/cooling/heating cycles, a cache attack, a memory attack, other exploit attack, covert communication, and combinations thereof.

24. The apparatus of claim 20, wherein decompose the received signal from the target device into the plurality of windows, wherein each window is the time slice further comprises one or more of the following program instructions, stored on the one or more computer readable storage media, to:
decompose the received signal into In-Phase/Quadrature (I/Q) data.

25. The apparatus of claim 20, wherein the hardware anomaly detector is further configured to:
determine a power spectral density of each window of the plurality of windows, wherein the power spectral density is determined using a discrete Fourier Transform; and
determine whether an instruction is being executed on the target device using a multi variate Gaussian probability density function, wherein the multi variate Gaussian probability density function is a statistical machine learning technique.
